(19) United States
(12) Patent Application Publication
(10) Pub. No.: US 2004/0173306 A1
(43) Pub. Date: Sep. 9, 2004

(54) Particleboard and method for forming a particleboard

(75) Inventors: Shelby F. Thames, Hattiesburg, MS (US); Richard C. Cook, Evansville, IN (US); Qiang Wang, Fountain Vally, CA (US); Sharathkumar K. Mendon, Hattiesburg, MS (US)

Correspondence Address: HOWREY LLP, HOWREY SIMON ARNOLD & WHITE, ATTORNEY AT LAW, 750 Bering Drive, Houston, TX, 77057-2198, US

(73) Assignee: University of Southern Mississippi

(21) Appl. No.: 10/280,119

(22) Filed: Oct. 24, 2002

(51) Int. Cl. C09J 5/04

(52) U.S. Cl. 156/317

(57) ABSTRACT

A binder system made from renewable resources is used to produce particleboards. In a preferred embodiment the binder includes soy protein isolate, a plasticizer such as glycerol and a vegetable oil derivative such as maleinized methyl ester of tung oil. Particleboard is formed from a source of lignocellulose, the binder, and optionally an alkali modified soy protein and emulsified wax.

### BACKGROUND

The present invention is directed to particleboards and other cellulosic composites. Additionally, the present invention is directed to a process for forming such particleboards using a soy protein binder.

Commercial particleboards are constructed in a range of thicknesses and are designed to have high-density surfaces and low-density cores so as to maximize strength while minimizing weight. Panel thickness for particleboards generally range from ½-1 inches with ⅝ and ¾ inches being the most common thicknesses in the industry. Particleboard is classified and evaluated according to the ANSI A208.1 requirements and ASTM D-1037 tests are used to determine the physical strength and water resistance properties.

Particleboards are formed by mixing together wood furnish and an adhesive binder and treating the mixture under high temperatures and pressures in a press. Generally, binder concentrations of 7-10% are used to make particleboard. Accordingly, the wood furnish is considered to be spot welded together rather than imbedded within the adhesive. Consequently, the ASTM D-1037 test results often exhibit a coefficient of variance in excess of 10%.

Many different types of resins can be used to make particleboard with urea formaldehyde resins being the most common. However, increasing environmental awareness in the recognized hazards of formaldehyde based wood glues has created a strong demand for more environmentally friendly wood composites. Successful replacement of urea formaldehyde resins in particleboard requires an adhesive that can produce composites having characteristics matching or exceeding those attainable with urea formaldehyde. Accordingly, water resistance is a necessary characteristic of any suitable replacement.

Soy protein was used as an adhesive ingredient in plywood in the early 1900s. However, the problem of low moisture resistance led to its replacement with petroleum based resins in the 1930s. However, if the water resistance of soy protein based adhesives could be improved, such an adhesive could provide an environmentally friendly replacement for urea formaldehyde resins.

In view of the foregoing, it would be a significant advancement in the art to provide a process for making particleboards and other composites utilizing an environmentally friendly adhesive made from renewable resources. It would be a further advancement if such a process produced a particleboard having properties equal to those of conventional products currently made with urea formaldehyde resins. Such a process and product are disclosed and claimed herein.

### SUMMARY OF THE INVENTION

The present invention is directed to processes for forming particleboard and other composite materials and the products formed by the process. In a preferred embodiment, the process comprises mixing wood furnish with a binder comprising a mixture of soy protein, a plasticizer and a vegetable oil derivative and processing the mixture in a heated press. In a second preferred embodiment an alkali modified soy protein dispersion in water is mixed with the wood furnish prior to adding the binder. A small amount of water is added to the mixture as it is placed in the press to increase the water content of the mixture and facilitate heat transfer. In the preferred embodiments, the soy protein is in the form of a powder adhesive and the alkali modified soy protein is in liquid form.

### BRIEF DESCRIPTION OF THE DRAWINGS

FIG. 1 is a graph of internal bond strength versus density for particleboard samples having an adhesive made from soy protein isolate, glycerol and lignosulfonate.

FIG. 2 is a graph of internal bond strength versus density for particleboard samples having an adhesive made from soy protein isolate, glycerol, maleinized methyl ester of tung oil and lignosulfonate.

FIG. 3 is a graph of internal bond strength versus density for particleboard samples having the same adhesive as those in FIG. 2 but with a higher concentration of adhesive in the core.

FIG. 4 is a composite graph of the information contained in FIGS. 2 and 3.

### DETAILED DESCRIPTION

Particleboards and other composite materials can be formed using adhesives made from renewable resources. The present invention provides methods for making such particleboards and composite materials.

In a preferred embodiment, the present invention uses a soy protein based powder adhesive to make particleboard. The adhesive comprises a mixture of soy protein isolate, a polyol plasticizer, a vegetable oil derivative and lignosulfonate.

The preferred vegetable oil derivatives are maleinized vegetable oils. A particularly preferred vegetable oil derivative is the maleinized methyl ester of tung oil. Other vegetable oils suitable for use in the present invention include soybean oil, castor oil, linseed oil, perilla oil, coconut oil, lesquerella oil, vemonia oil, cottonseed oil, safflower oil and sunflower oil.

The adhesive can optionally include additional ingredients to improve the properties of the particleboard. One such component is lignosulfonate. The formulation of particleboard can optionally include additional ingredients to improve the water resistance properties of the particleboard. Two such components are alkali modified soy protein and emulsified wax. The formulation of particleboard can optionally include additional ingredients to improve the heat transfer such as m-chloroperoxy benzoic acid.

Particleboard is generally made by mixing wood furnish with an adhesive and treating the mixture in a heated press. While the preferred embodiment of the present invention involves the formation of particleboard using wood furnish, it will be appreciated that other cellulosic materials such as wood chips, sawdust and natural fibers such as bagasse, bamboo, kenaf and hemp can also be used.

The invention is best illustrated by the following examples which describe preferred embodiments of the present invention. However, it should be appreciated that the examples are illustrative only and are not limiting as to the scope of the invention.

### EXAMPLE 1

The powder adhesive used to make the particleboards tested in the following examples was prepared as follows:

The vegetable oil derivative used in the adhesive was the maleinized methyl ester of tung oil and was synthesized by heating the methyl ester of tung oil to 80° C., adding excess maleic anhydride while stirring and allowing the components to react for 6-8 hours. Unreacted maleic anhydride was then removed via sublimation and the anhydride equivalent weight was determined by assaying the product with standarized methanolic alkali. A maleinized methyl ester of tung oil having an anhydride equivalent weight of about 410 g/mol was produced.

The powder adhesives utilized in the following examples were prepared by blending the ingredients in a sealed, ceramic ball mill jar using 1-inch alumina mixing stones. The liquid components were first added to the ball mill jar which was sealed and placed on rollers. After mixing, the jar was removed from the rollers and inspected to insure that the liquids uniformly coated the stones and jar walls. The dry ingredients were then mixed together and added to the jar. The jar was resealed, placed on the rollers and the speed was adjusted until the stones began to cascade. Blending was stopped periodically and the ingredients scraped from the inside walls of the jar until the texture changed from a non-homogeneous mixture to a uniform cohesive blend. The mixing stones were removed from the adhesive by pouring the ball mill contents onto a wire screen with ½ inch openings.

Two powder adhesive formulations were prepared. The first powder adhesive formulation comprised 65% soy protein isolate, 30% glycerol and 5% lignosulfonate. The second powder adhesive composition contained 60% soy protein isolate, 20% glycerol, 15% maleinized methyl ester of tung oil and 5% lignosulfonate.

### EXAMPLES 2-4

A plurality of particleboards were prepared and tested using three different formulations. The particleboards were produced using two aluminum cauls, i.e., top and bottom, and a 17-inch by 9-inch forming box that was 10 inches deep. The samples were made with small wood furnish particles, i.e., less than 5 mm in length at the surfaces with wood furnish of varying particle sizes in the core. The particleboard mats were designed to be ½-inch thick after cure and had a three layer construction with a face/core/face material weight ratio of 27:46:27 and a 50 lb/ft³ target density. Due to material loss around the edges of the mat during compression, the mats produced boards that were 15 inches long and 6 inches wide after the edges were removed.

Adhesive concentrations ranged from 7 to 10 wt % and were blended with face and core wood furnish separately in a high-speed Henschel blender. Wood furnish and adhesive were added to the blender and allowed to mix at 1,000 rpm for one minute. Particleboard mats were formed by hand using the forming box and aluminum cauls. Mat production began by placing the forming box on a caul and adding optional water to the surface as a mist. Next, one-half the facial adhesive/wood furnish blend was added to the box, followed by the core, and finally the remaining facial material. After each adhesive/wood furnish blend addition, the material was smoothed by hand and once all material was added, a temporary wood insert was used to compress the mat while removing the forming box. The final step consisted of misting water onto the mat surface, adding the second caul, and placing the mat into the heated press. Mats were cured at 165° C. while increasing the pressure to 500 psi and holding for 30 seconds, then reducing the pressure to 350 psi and holding for the remainder of the curing cycle, which was 270 seconds. Once cured, pressure was slowly reduced and the board was removed from the press, separated from the cauls, and placed on its side to cool. The size constraint of the press platens produced either two 3-inch×15-inch samples for testing modulus of rupture (MOR) and modulus of elasticity (MOE) or multiple 2×2-inch samples, for testing internal bond strengths (IB), face pull (FP), thickness swelling (TS) and water absorption (WA). However values were also obtained for MOR, MOE, IB, and FP from a single board cutting the 2-inch specimens from the MOR/MOE test panels. All mats were cooled for at least 24 hours prior to testing.

The compositions of the samples were as follows:

TABLE 1

| Ex- | Adhesive Formulation | Adhesive |
|---|---|---|
| ample | (wt. %) | Concentration (wt. %) |
| 2 | 65% soy protein isolate | 10% in Face |
| | 30% glycerol | 7% in Core |
| | 5% lignosulfonate | |
| 3 | 60% soy protein isolate | 10% in Face |
| | 20% glycerol | 7% in Core |
| | 15% maleinized methyl ester of tung oil | |
| | 5% lignosulfonate | |
| 4 | 60% soy protein isolate | 10% in Face |
| | 20% glycerol | 10% in Core |
| | 15% maleinized methyl ester of tung oil | |
| | 5% lignosulfonate | |

The effects of MMETO and its concentration on composite strength and water resistance were determined via IB, TS, and WA. FIGS. 1-3 compare the IB strengths versus density for the composites. All boards had a similar density range, e.g., 52 to 60 lbs/ft³ and the composites containing 7 wt % adhesive in the core and no MMETO exhibited IB values between 50 and 80 psi with an average IB of 68±11 psi. (See FIG. 1.) Composites produced with 7 wt % adhesive in the core containing 15 wt % MMETO showed similar IB results as the boards without MMETO and had an average IB equal to 74±12 psi. (See FIG. 2.) However, upon addition of 10 wt % of the MMETO-based adhesive to the core, the average IB value rose to 88±16 psi with a maximum value of 117 psi. (See FIG. 3.) The increased IB values are more clearly seen in FIG. 4 and are the result of improved strength via increased wood furnish coverage by higher binder concentrations. Although the average IB valued increased with increasing adhesive concentration, the coefficient of variance for both adhesive levels was greater than 15% due to adhesive spot-welds.

Water submersion results for these composites showed that the boards without MMETO were stable in water for less than 24 hours and the average 2-hour water absorption and thickness swelling values were 58±7% and 43±9%, respectively. On the other hand, composites containing MMETO in the adhesive showed dramatic improvement in the 2-hour water resistance and extended the stability to 24-hours at both adhesive concentrations. The 7 wt % MMETO adhesive reduced the 2-hour WA and TS to 18±7% and 16±8%, respectively. Submersion tests for composites with 10 wt % MMETO adhesive yielded 2-hour WA and TS of 12±6% and 8±6%.

### Example 5

The powder adhesive used to make the particleboards tested in the following example contained 52% soy protein isolate, 17% glycerol, 13% maleinized methyl ester of tung oil, 4% lignosulfonate, 13% alkali modified protein and 1% emulsified wax.

The alkali modified protein used in making particleboard was alkali modified soy protein isolate and was synthesized by heating a dispersion of ˜15% soy protein isolate and deionized water to 70° C., adding ammonia to adjust the pH to 8˜9 while stirring and allowing the components to react for 30 minutes. 1% sodium benzoate was added at the end of the preparation as a preservative. Alkali modified protein is a water dispersion that was stable at room temperature for about 5 days.

A plurality of particleboards were prepared and tested. The particleboards were produced using two aluminum cauls, i.e., top and bottom, and a 17-inch by 9-inch forming box that was 10 inches deep. The samples were made with small wood furnish particles, i.e., less than 5 mm in length at the surfaces with wood furnish of varying particle sizes in the core. The particleboard mats were designed to be ½-inch thick after cure and had a three layer construction with a face/core/face material weight ratio of 27:46:27 and a 50 lb/ft³ target density. Due to material loss around the edges of the mat during compression, the mats produced boards that were 15 inches long and 6 inches wide after the edges were removed.

The 13% alkali modified protein was first blended with face and core wood furnish separately in a high-speed Henschel blender. The total amount of alkali modified protein was separated into three parts and added into the blender in three steps and allowed to mix at 700 rpm for one minute for each step. Then 1% emulsified wax (concentration of wax was 50%) was added and mixed with the above mixture at 700 rpm for 1 minute. Then the mixture of powder adhesive (10 wt % based on the weight of the mixture of wood furnish and powder adhesive) and 3-chloroperoxide benzoate acid (1 wt % based on the weight of the mixture of wood furnish and powder adhesive) powder adhesive were added to the blender and allowed to mix at 700 rpm for one minute, stop, 15 seconds, stop, 1 minute at 1000 rpm. Particleboard mats were formed by hand using the forming box and aluminum cauls. Mat production began by placing the forming box on a caul and adding optional water to the surface as a mist. Next, one-half the facial adhesive/wood furnish blend was added to the box, followed by the core, and finally the remaining facial material. After each adhesive/wood furnish blend addition, the material was smoothed by hand and once all material was added, a temporary wood insert was used to compress the mat while removing the forming box. The final step consisted of misting water onto the mat surface, adding the second caul, and placing the mat into the heated press. Mats were cured at 165° C. while increasing the pressure to 500 psi and holding for 30 seconds, then reducing the pressure to 350 psi and holding for the remainder of the curing cycle, which was 270 seconds. Once cured, pressure was slowly reduced and the board was removed from the press, separated from the cauls, and placed on its side to cool. The effect of the combination of alkali modified protein and emulsified wax was determined via WA and TS.

As shown in example 2-4, water submersion results for those composites showed that the 2-hour WA and TS for the boards without alkali modified protein and emulsified wax were 18±7% and 16±8%, respectively. The combination of alkali modified protein and emulsified wax in the boards of this example dramatically reduced the 2-hour WA and TS to 5.57% and 2.84%, respectively.

While the invention has been described with respect to the presently preferred embodiments, it will be appreciated that changes and modifications can be made without departing from the spirit of the invention. Accordingly, the scope of the invention is to be determined by the following claims rather than the foregoing description.

What is claimed is:

1. A process for forming particleboard comprising:
mixing a source of lignocellulose with a binder, said binder comprising a mixture of soy protein, a plasticizer, and a vegetable oil derivative;
adding water to said mixture; and
processing said mixture in a heated press.

2. A process for forming particleboard as defined in claim 1 wherein the soy protein comprises soy protein isolate.

3. A process for forming particleboard as defined in claim 1 wherein the plasticizer comprises a polyol.

4. A process for forming particleboard as defined in claim 3 wherein the polyol comprises glycerol.

5. A process for forming particleboard as defined in claim 1 wherein the vegetable oil derivative comprises a maleinized vegetable oil derivative.

6. A process for forming particleboard as defined in claim 5 wherein the vegetable oil derivative comprises maleinized methyl ester of tung oil.

7. A process for forming particleboard as defined in claim 1 wherein the source of lignocellulose is wood furnish.

8. A process for forming particleboard as defined in claim 1 wherein the mixture is processed between first and second cauls and the step of adding water comprises misting water onto a surface of the first caul before adding the mixture and misting the surface of the mixture before applying the second caul.

9. A process for forming particleboard as defined in claim 1 further comprising adding alkali modified soy protein to the source of lignocellulose prior to adding the binder.

10. A process for forming particleboard as defined in claim 9 further comprising adding emulsified wax to the source of lignocellulose prior to adding the binder.

11. A process for forming particleboard comprising:
mixing an alkali modified soy protein with a source of lignocelluloses to form a first mixture;
mixing a binder with the first mixture, the binder comprising a mixture of soy protein, a plasticizer, and a vegetable oil derivative to form a second mixture; and
processing said second mixture in a heated press.

12. A process for forming particleboard as defined in claim 11 further comprising adding emulsified wax to the first mixture.

13. A process for forming particleboard as defined in claim 11 wherein the vegetable oil derivative comprises a maleinized vegetable oil derivative.

14. A process for forming particleboard as defined in claim 11 wherein the source of lignocellulose comprises wood furnish.

15. A particleboard comprising:
a source of lignocellulose;
an alkali modified soy protein; and
a binder comprising a mixture of soy protein, a plasticizer, and a vegetable oil derivative.

16. A particleboard as defined in claim 15 further comprising an emulsified wax.

17. A particleboard as defined in claim 15 wherein the source of lignocellulose comprises wood furnish.
